(19) United States
(12) Patent Application Publication
(10) Pub. No.: US 2019/0372251 A1
(43) Pub. Date: Dec. 5, 2019

(54) HIGH-SPEED CONNECTOR ON HIGH-DENSITY MINI VERSION CHIP SIDE

(71) Applicant: LUXSHARE PRECISION INDUSTRY Co., Ltd., Shenzhen (CN)

(72) Inventors: Bin HUANG, Shenzhen (CN); Tiesheng LI, Shenzhen (CN); Hongji CHEN, Shenzhen (CN); Kun LIU, Shenzhen (CN)

(73) Assignee: LUXSHARE PRECISION INDUSTRY Co., Ltd., Shenzhen (CN)

(21) Appl. No.: 16/397,406

(22) Filed: Apr. 29, 2019

(30) Foreign Application Priority Data
May 30, 2018 (CN) 201820826642.0

(51) Int. Cl. H01R 12/70; H01R 12/79; H01R 12/58

(52) U.S. Cl. CPC H01R 12/7023; H01R 12/58; H01R 12/79

(57) ABSTRACT

The present invention provides a high-speed connector on a high density MINI version chip side, which comprises a board end connector, a wire end connector and a printed circuit board; the board end connector is arranged on the printed circuit board; the board end connector comprises a board end connector shell and a board end connector body arranged in the board end connector shell; the wire end connector comprises a wire end case and a tongue plate fixed to the wire end case; wherein at least one guide piece is extended from the board end connector shell, and the wire end case is provided with at least one guide slot for creating a butt joint with the guide piece. The connector of the present invention utilizes the space of the board end to the maximum extent, solves the problem that the CPU occupies the space of the board end due to the increased size of the heat dissipation module, and can realize high-speed data transmission.

### CROSS-REFERENCE TO RELATED APPLICATIONS

This non-provisional application claims priority under 35 U.S.C. § 119(a) on Patent Application No. 201820826642.0 filed in P.R. China on May 30, 2018, the entire contents of which are hereby incorporated by reference.

Some references, if any, which may include patents, patent applications and various publications, may be cited and discussed in the description of this invention. The citation and/or discussion of such references, if any, is provided merely to clarify the description of the present invention and is not an admission that any such reference is “prior art” to the invention described herein. All references listed, cited and/or discussed in this specification are incorporated herein by reference in their entireties and to the same extent as if each reference was individually incorporated by reference.

### TECHNICAL FIELD

The present invention relates to a connector, in particular to a high-speed connector on the chip side of a high-density MINI version.

### BACKGROUND ART

With the increase of the network age, the requirements on data processing and transmission speed are increased, the performance and device density of the corresponding servers, workstations and CPUs in the I/O memory are synchronously improved, and certain challenges are brought to the device size and the heat dissipation of the servers. Generally, the heat sink occupies a large space on the printed circuit board, and the space between the heat sink and the printed circuit board in the height direction is small, such that the conventional connector cannot be arranged below the heat sink, and it is difficult to utilize the redundant space below the heat sink, resulting in wasted space of the printed circuit board is wasted.

### DISCLOSURE OF THE PRESENT INVENTION

The present invention provides a high-speed connector on a high-density MINI version chip side, which has small size and the height of less than 3.7 mm, can be placed under a heat sink of a chip, and has the transmission speed up to 56 Gbit/s. The space of the board end is utilized to the maximum extent, and the problem that the CPU occupies the space of the board end due to the size expansion of the radiating module is solved.

To achieve the above object, the present invention provides a high-speed connector on a high-density MINI version chip side, comprising: a board end connector, a wire end connector and a printed circuit board; the board end connector is arranged on the printed circuit board; the board end connector comprises a board end connector shell and a board end connector body arranged in the board end connector shell; the wire end connector comprises a wire end case and a tongue plate fixed to the wire end case; wherein at least one guide piece extends from the board end connector shell, and the wire end case is provided with at least one guide slot for creating a butt joint with the guide piece.

The present invention also provides a printed circuit board layout structure, comprising: a connector, a chip and a heat sink arranged on the chip, the connector is arranged below the heat sink, the connector comprises: a board end connector, a wire end connector and a printed circuit board; the board end connector is arranged on the printed circuit board; the board end connector comprises a board end connector shell and a board end connector body arranged in the board end connector shell; the wire end connector comprises a wire end case and a tongue plate fixed to the wire end case; wherein at least one guide piece extends from the board end connector shell, and the wire end case is provided with at least one guide slot for creating a butt joint with the guide piece.

The beneficial effects of the present invention are: the space of the board end is utilized to the maximum extent, the problem that the CPU occupies the space of the board end due to the increased size of the heat dissipation module is solved, and high-speed data transmission can be realized.

The present invention will be described in detail below with reference to the following drawings and embodiments, but the present invention is not limited thereto.

### BRIEF DESCRIPTION OF THE DRAWINGS

FIG. 1 is a perspective view of the connector of the present invention in a separated state;

FIG. 2 is a perspective view of the connector of the present invention in a use state;

FIG. 3 is a schematic top view of the connector of the present invention;

FIG. 4 is a schematic side view of the connector of the present invention;

FIG. 5 is an enlarged schematic view of the connected portions of the connector of the present invention;

FIG. 6 is a partial schematic view of the unlocking snap portion of the connector of the present invention;

FIG. 7 is an enlarged schematic view of the engagement portion of the connector of the present invention;

FIG. 8 is an exploded view of the board end connector of the present invention;

FIG. 9 is a schematic diagram of a system using the connector of the present invention;

FIG. 10 is an exploded view of the connector of the present invention.

### LIST OF THE REFERENCE NUMERALS:

100 Connector

101 Board end connector shell

102 Board end connector body

103 Wire end case

104 Tongue plate

105 Unlocking snap

106 Board end connector

107 Wire end connector

109 Printed circuit board

110 Guide piece

111 Guide projection

112 Guide slot

113 Welding foot

114 Snap slot

115 Slot

116 Step

117 Conductive terminal

118 Conductive plastic

### DETAILED DESCRIPTION OF THE EXEMPLARY EMBODIMENTS

The structural principle and the operational principle of the present invention will be described in detail below with reference to the attached drawings:

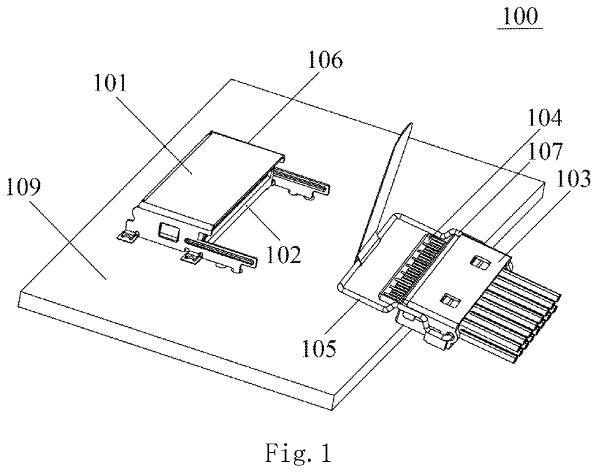

FIG. 1 is a perspective view showing the connector of the present invention in separated state. As shown in FIG. 1, the high-speed connector 100 on high density MINI version chip side of the present invention includes a board end connector 106, a wire end connector 107 and a printed circuit board 109. Both of the board end connector 106 and the wire end connector 107 are used cooperatively.

The board end connector 106 is mounted on the printed circuit board 109 and comprises a board end connector shell 101 and a board end connector body 102 embedded in the board end connector shell 101.

The wire end connector 107 comprises a wire end case 103, a tongue plate 104, a wire end body (not shown) and an unlocking snap 105. The tongue plate 104 is covered by the wire end body, the wire end case 103 covers the wire end body and is fixed to the wire end body, and the unlocking snap 105 is arranged at both sides of the wire end case 103.

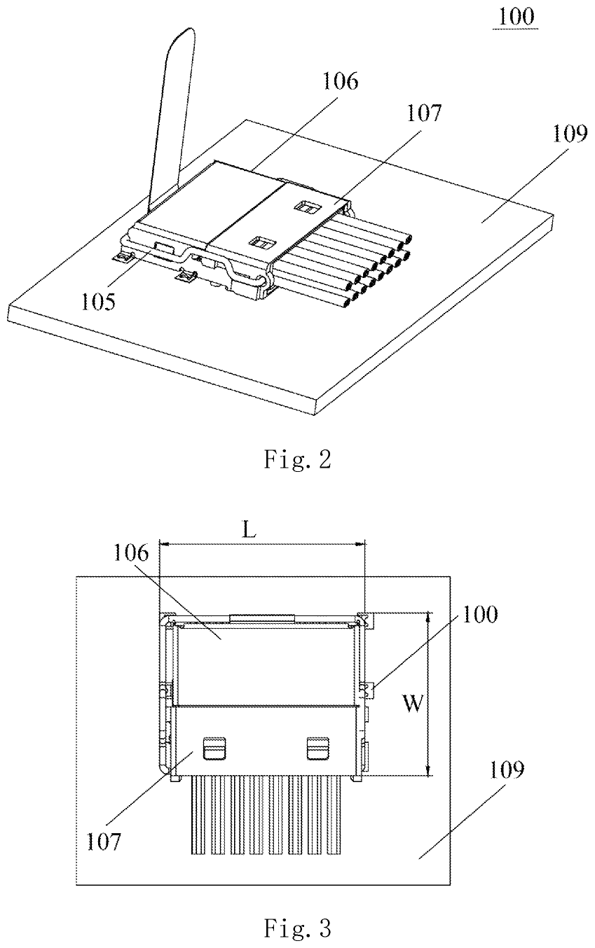

FIG. 2 is a perspective view showing the connector of the present invention in a use state. As shown in FIG. 2, when using, the wire end connector 107 is aligned with the board end connector 106 and inserted into the board end connector 106, and the unlocking snap 105 is pressed after insertion, such that the wire end connector 107 and the board end connector 106 can be tightly combined.

FIG. 3 is a schematic top view of the connector of the present invention. As shown in FIG. 3, the connector 100 of the present invention has a body portion of a length L, preferably 18-20 mm, and a width W, preferably 13-15 mm, after the wire end connector 107 is coupled to the board end connector 106.

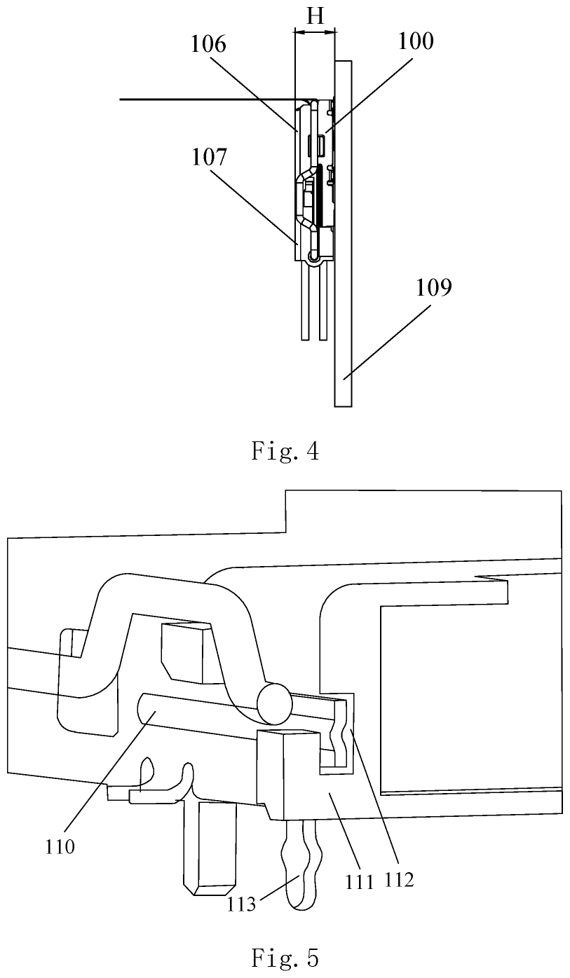

FIG. 4 is a schematic side view of the connector of the present invention. As shown in FIG. 4, the connector 100 of the present invention has a body portion of a thickness H less than 3.7 mm, after the wire end connector 107 is coupled to the board end connector 106.

FIG. 5 is an enlarged schematic view of the connected portions of the connector of the present invention. As shown in FIG. 5, both sides of the board end connector shell 101 are provided with two guide pieces 110 extending outwards from the board end connector 106, and the guide pieces 110 are integrally formed with the board end connector shell 101. Both sides of the wire end case 103 have at least one guide projection 111 extending outward, and the guide projection 111 is integrally formed with the wire end case 103. Both side surfaces of the wire end case 103 have guide slots 112 recessed toward each other. The guide projection 111 is disposed at an edge of the guide slot 112, and the guide projection 111 surrounds at least a portion of the guide slot 112.

When inserting the wire end connector 107 into the board end connector 106, the wire end connector 107 should be inserted into the board end connector 106 after aligning the two guide pieces 110 of the board end connector 106 with the guide slots 112 of the wire end connector 107. During the plugging process, the guide pieces 110, the guide projection 111 and the guide slots 112 are matched with each other, to provide a plugging alignment mechanism for the wire end connector 107 and the board end connector 106, and prevent improper plugging in the wrong direction.

When the wire end connector 107 is inserted into the board end connector 106, the guide piece 110 is inserted into the guide slot 112, such that the guide piece 110 is disposed between the wire end case 103 and the guide projection 111, the guide projection 111 located on both sides of the guide piece 110 abuts against the guide piece 110, so it is possible to prevent the wire end connector 107 from applying an improper force in a direction other than the abutting direction due to the wire bending, and to reduce the damage when the board end connector 106 is butt jointed with the wire end connector 107.

In addition, a welding foot 113 is disposed at one end of the guide piece 110, and the welding foot 113 is formed by the extension of the guide piece 110 and is integrally formed with the guide piece 110. The welding foot 113 is inserted on the printed circuit board 109 and can serve to fix the guide piece 110 to enhance the fixing strength of the guide piece 110.

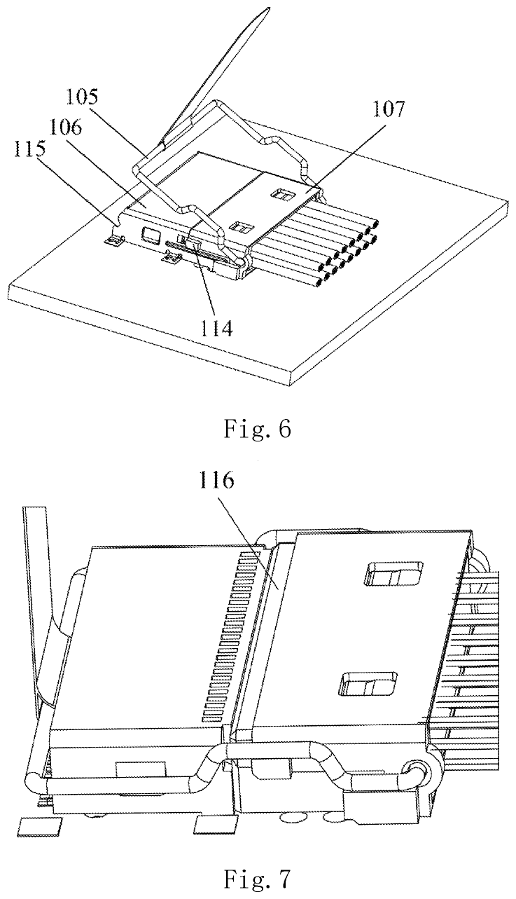

FIG. 6 is a schematic view of the unlocking snap portion of the connector of the present invention. The wire end case 103 is provided with snap slots 114 at both sides of the outside of the wire end case, and the rear end of the board end connector shell 101 is provided with a slot 115. After the wire end connector 107 is inserted into the board end connector 106, the unlocking snap 105 is pressed such that the unlocking snap 105 is snapped into the slot 115, the snap slot 114 is abutted against the unlocking snap 105, and the guide piece 110 is accommodated in the guide slot 112. Because the guide piece 110 fastens the wire end case 103 of the wire end connector 107, the wire end connector 107 may lower the displacement in the direction of the vertical butt joint, in which the guide projection 111 and the snap slot 114 are disposed on both sides of the guide piece 110. Due to the design of disposing the guide projection 111 and the snap slot 114 on both sides of the guide piece 110, it is possible to prevent the movement of the wire end connector 107 caused by the excessive bending of the wire on the side of the wire end connector 107 and also prevent the connector from being warped upward thereby resulting in damage.

FIG. 7 is an enlarged schematic view of the engagement portion of the connector of the present invention. As shown in FIG. 7, a step 116 is disposed on a portion of the upper surface of the wire end case 103, which is combined with the board end connector 106, such that after the wire end connector 107 is combined with the board end connector 106, a portion of the wire end case 103 is embedded in the board end connector shell 101 to form an overlapping portion, which can prevent the peripheral circuit or device from interfering with the connector.

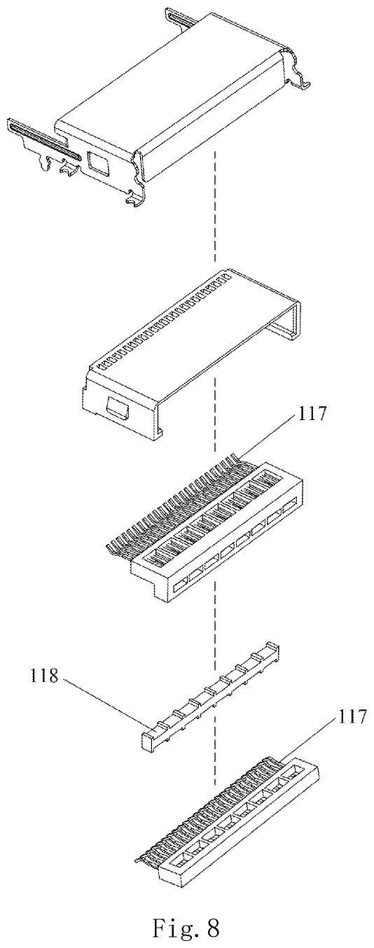

FIG. 8 is an exploded view of the board end connector of the present invention. As shown in FIG. 8, the board end connector 106 includes an upper layer and a lower layer of terminals 117 with a conductive plastic 118 disposed therebetween for optimizing the signal integrity resonance of the connector.

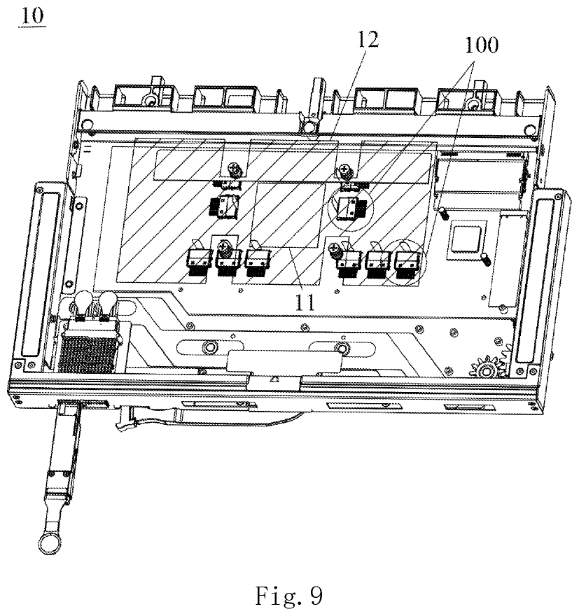

FIG. 9 is a schematic diagram of a system using the connector of the present invention. As shown in FIG. 9, the system 10 using the connector 100 of the present invention includes a chip 11, a heat dissipation module 12, and the connector 100. As shown, the connector 100 is disposed below the heat dissipation module 12 and is disposed at a side of the chip 11. Therefore, the space below the heat dissipation module 12 can be fully utilized, the space of the printed circuit board is utilized to the maximum extent, and the problem that the CPU occupies the space due to the increased size of the heat dissipation module is solved.

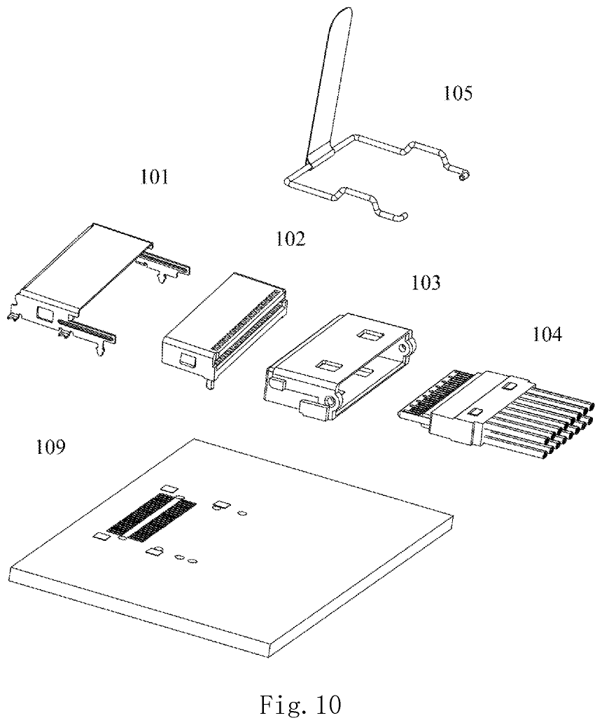

FIG. 10 is an exploded view of the connector of the present invention. Its specific structure has been explained and the same contents will not be repeated.

The present invention may be embodied in other forms, various changes and modifications may be made by one skilled in the art without departing from the spirit or essence of the invention, and the corresponding changes and modifications will fall into the scope of the invention as defined by the appended claims.

1. A high speed connector on high density MINI version chip side, comprises:
a board end connector, a wire end connector and a printed circuit board,
wherein the board end connector is arranged on the printed circuit board,
wherein the board end connector comprises a board end connector shell and a board end connector body arranged in the board end connector shell,
wherein the wire end connector comprises a wire end case, a tongue plate and a wire end body cladding the tongue plate, and the wire end body is clad by the wire end case,
wherein at least one guide piece is extended from the board end connector shell, and the wire end case is provided with at least one guide slot for creating a butt joint with the guide piece.

2. The high speed connector on high density MINI version chip side of claim 1, wherein the guide piece comprises at least one welding foot inserted on the printed circuit board.

3. The high speed connector on high density MINI version chip side of claim 1, wherein an edge of the guide slot is provided with at least one guide projection.

4. The high speed connector on high density MINI version chip side of claim 3, wherein the guide projection is formed by an extension of the wire end case and surrounds at least a portion of the guide slot.

5. The high speed connector on high density MINI version chip side of claim 3, wherein the guide piece is disposed between the at least one guide projection and the wire end case.

6. The high speed connector on high density MINI version chip side of claim 3, wherein the board end connector shell and the wire end case on the printed circuit board each has a height less than 3.7 mm.

7. The high speed connector on high density MINI version chip side of claim 1, wherein the board end connector shell covers a portion of the wire end case.

8. The high speed connector on high density MINI version chip side of claim 1, wherein the wire end case is provided with an unblocking snap to be buckled with the board end connector shell.

9. The high speed connector on high density MINI version chip side of claim 1, wherein two guide pieces are arranged on both sides of the board end connector shell, respectively, and two guide slots are arranged on both sides of the wire end case, respectively.

10. A printed circuit board layout structure, comprises:
a connector, a chip and a heat sink arranged on the chip, the connector arranged below the heat sink and comprising:
a board end connector, a wire end connector and a printed circuit board,
wherein the board end connector is arranged on the printed circuit board,
wherein the board end connector comprises a board end connector shell and a board end connector body arranged in the board end connector shell,
wherein the wire end connector comprises a wire end case and a tongue plate fixed to the wire end case;
wherein at least one guide piece is extended from the board end connector shell, and the wire end case is provided with at least one guide slot for creating a butt joint with the guide piece.

11. The printed circuit board layout structure of claim 10 wherein the guide piece comprises at least one welding foot inserted on the printed circuit board.

12. The printed circuit board layout structure of claim 10, wherein an edge of the guide slot is provided with at least one guide projection.

13. The printed circuit board layout structure of claim 12, wherein the guide projection is formed by an extension of the wire end case and surrounds at least a portion of the guide slot.

14. The printed circuit board layout structure of claim 12, wherein the guide piece is disposed between the at least one guide projection and the wire end case.

15. The printed circuit board layout structure of claim 12, wherein the board end connector shell and the wire end case on the printed circuit board each has a height less than 3.7 mm.

16. The printed circuit board layout structure of claim 10, wherein the board end connector shell covers a portion of the wire end case.

17. The printed circuit board layout structure of claim 10, wherein the wire end case is provided with an unblocking snap to be buckled with the board end connector shell.

18. The printed circuit board layout structure of claim 10, wherein two guide pieces are arranged on both sides of the board end connector shell, respectively, and two guide slots are arranged on both sides of the wire end case, respectively.
